(19) United States
(12) Patent Application Publication
(10) Pub. No.: US 2008/0212861 A1
(43) Pub. Date: Sep. 4, 2008

(54) Revolutionary Series Control for Medical Imaging Archive Manager

(75) Inventors: Jacob Durgan, Willoughby Hills, OH (US); Melinda Steinmiller, Atlanta, GA (US)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N. V., Eindhoven (NL)

(21) Appl. No.: 11/996,794

(22) PCT Filed: Jul. 17, 2006
(86) PCT No.: PCT/IB06/52432

§ 371 Date: Jan. 25, 2008

Related U.S. Application Data
(60) Provisional application No. 60/702,587, filed on Jul. 26, 2005.

(51) Int. Cl. G06K 9/00

(52) U.S. Cl. 382/131

(57) ABSTRACT

A series control algorithm (48) generates an interactive user interface screen (46) on a display (22) and enables a user to simultaneously control series and image levels operations associated with a selected study by interactively selecting and viewing the medical images retrieved from an archive (16), which includes a plurality of medical images hierarchically organized at study, series and image levels (60, 62, 64), at the series level.

The present invention relates to diagnostic imaging systems and methods. It finds particular application in conjunction with visualization of images for Computed Tomography (CT) imaging and will be described with particular reference thereto. However, it is to be appreciated that the invention will also find application in conjunction with visualization of images of other imaging modalities such as Single Photon Emission Computerized Tomography (SPECT), Photon Emission Tomography (PET), Magnetic Resonance Imaging (MRI), and the like.

Multi-slice CT (MSCT) imaging has achieved major technological breakthroughs in a short period of time. The sixteen slice CT scanner is rapidly becoming the workhorse of the radiology, ET and trauma departments. MSCT technology not only enables the acquisition of a large number of CT slices on a routine basis, but also the use of CT imaging to diagnose non-traditional anatomies, e.g. cardiovascular. The number of images per series and the number of series per study have significantly grown. The users find it difficult and cumbersome to navigate through the myriad of images.

In order to more easily manage a large number of images, many hospitals use a network of specialized equipment and components designed to support medical radiological imaging commonly referred to as a Picture Archiving and Communicating System (PACS). A PACS allows managing digital medical images including archiving, retrieving and displaying the images. For example, when a patient is imaged by a medical modality, digital images, are generated, captured and archived in DICOM (Digital Imaging and Communications in Medicine) format, which specify the conformance requirements for the relevant networking features. The DICOM standards are intended for use in communicating medical digital images among printers, workstations, acquisition modules and file servers. The DICOM system is designed to facilitate the communication of digital images of different types, e.g., X-ray, computerized tomography, magnetic resonance and ultrasound imaging.

Typically, within DICOM, the images are managed at three levels, e.g. study, series and image. A tree or a table is displayed, which lists all patients and under each patient all studies associated with that patient. As a first step, a radiologist selects a patient study. The selected patient study typically includes one or more series of images. The series are presented in a list of series, from which the radiologist selects one or more series to view or analyze. Once the series is selected, the radiologist can open a viewer to begin viewing or analyzing the images of the selected series. However, opening and viewing multiple images of simultaneously selected series is cumbersome. Within the open series, the images need to be selected by commonly used window environment tools such as computer control keys, shift keys, mouse select and drag buttons, and the like. As some datasets have a large number of images, e.g. 1000 to 4000 images per series, the multi-selection from more than one series to sub-select the same imaged region becomes problematic as it requires a great deal of scrolling, highlighting, dragging, etc. One example of such large studies is a run off study, e.g. a scan from a neck to ankles, which could include 4000 images. Another example is a cardiac study where the imaging is done in multiple phases, e.g. 10 phases with 300 images in each phase.

The present invention provides a new and improved apparatus and method which overcomes the above-referenced problems and others.

In accordance with one aspect, a diagnostic imaging system is disclosed. A series control algorithm generates an interactive user interface screen on a display and enables a user to simultaneously control series and image levels operations associated with a selected study by interactively selecting and viewing the medical images retrieved from an archive, which includes a plurality of medical images hierarchically organized at study, series and image levels, at the series level.

In accordance with another aspect, a method for displaying medical images is disclosed. A plurality of medical images which are hierarchically organized by patient at study, series, and image levels is stored. An interactive user interface screen is displayed on a display. With the displayed interface screen, the medical images are interactively selected and viewed concurrently from a plurality of series.

One advantage of the present invention resides in allowing the user to visualize and scroll through each available series from selected studies concurrently.

Another advantage resides in improved efficiency of the hospital.

Another advantage resides in eliminating one level from the archive manager image management system.

Another advantage resides in an ease of the selection and coordinated manipulation of multiple series at the same time.

Still further advantages and benefits of the present invention will become apparent to those of ordinary skill in the art upon reading and understanding the following detailed description of the preferred embodiments.

The invention may take form in various components and arrangements of components, and in various steps and arrangements of steps. The drawings are only for purposes of illustrating the preferred embodiments and are not to be construed as limiting the invention.

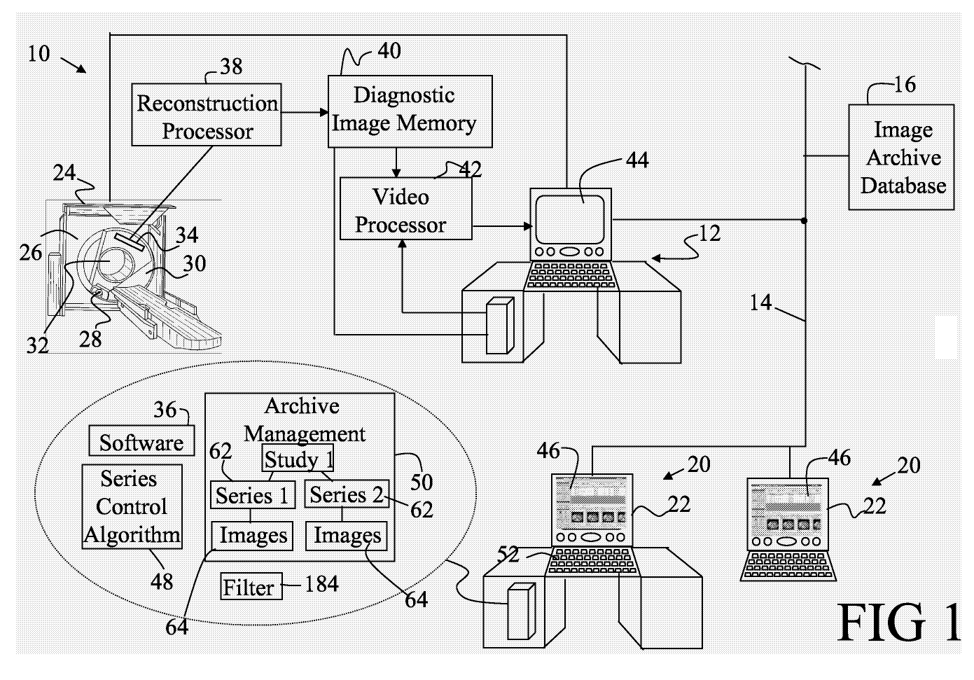

FIG. 1 is a diagrammatic illustration of an imaging system coupled to a hospital network;

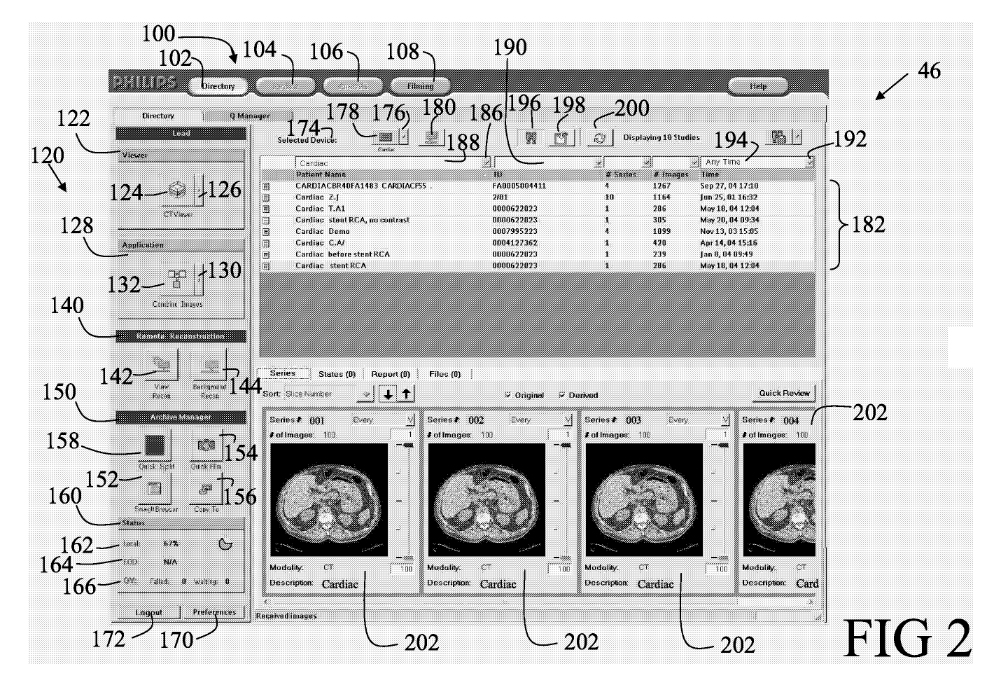

FIG. 2 is an image of a user interface screen;

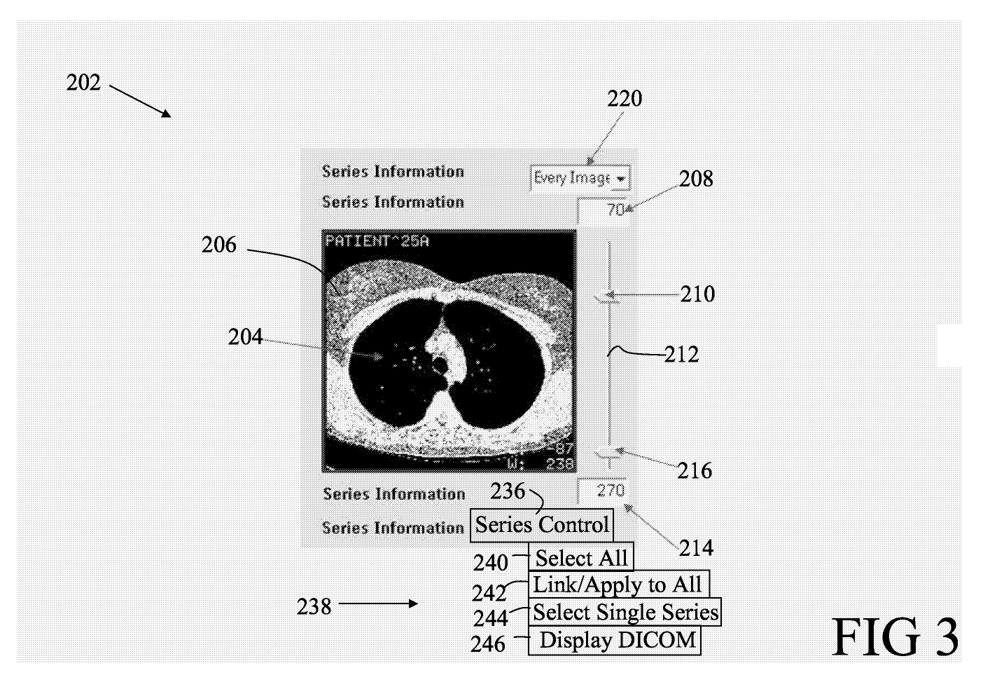

FIG. 3 is an image of a series control user interface screen; and

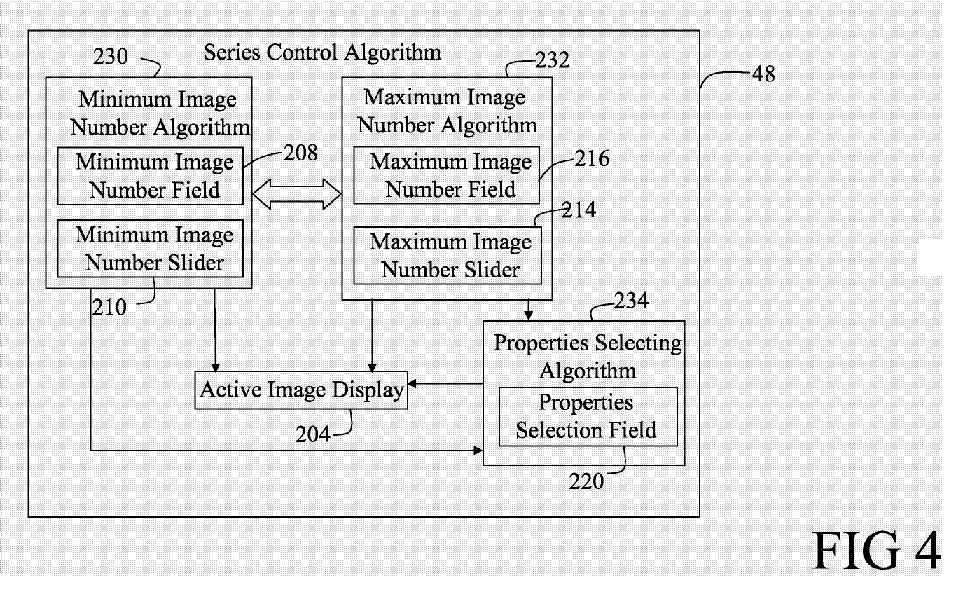

FIG. 4 is a diagrammatic illustration of a portion of the imaging system.

With reference to FIG. 1, an operation of an imaging system 10 is controlled from an operator workstation 12 which is coupled to a hospital network 14. The workstation 12 may be hardwired to the network 14 or may communicate with it wirelessly. In this manner, the workstation 12 can communicate with a central records or image archive database 16 and other hospital workstations or computers or remote means 20, which are connected to the hospital network 14, enabling the images and patient records to be stored, retrieved, and forwarded to the appropriate hospital personnel and displayed on associated monitors 22, for example, via PACS.

Typically, the imaging system 10 includes a CT scanner 24 including a non-rotating gantry 26. An x-ray tube 28 is mounted to a rotating gantry 30. A bore 32 defines an examination region of the CT scanner 24. An array of radiation detectors 34 is disposed on the rotating gantry 30 to receive radiation from the x-ray tube 28 after the x-rays transverse the examination region 32. Alternatively, the array of detectors 34 may be positioned on the non-rotating gantry 26. Typically, scanners of other types, such as MRI, SPECT, PET, ultrasound, and the like are also interconnected with the network 14 and archive generated images in the archive database 16.

Typically, the imaging technician performs a scan using the workstation 12 loaded with software 36. Diagnostic data from the scanner 24 is reconstructed by a reconstruction processor 38 into electronic image representations which are stored in a diagnostic image memory 40. The reconstruction processor 38 may be incorporated into the workstation 12, the scanner 24, or may be a shared resource among a plurality of scanners and workstations. The diagnostic image memory 40 preferably stores a three-dimensional image representation of an examined region of the subject. A video processor 42 converts selected portions of the three-dimensional image representation into appropriate format for display on a video monitor 44. Typically, a technician uses the workstation 12 to generate images. The generated images are sent to the archive database 16.

The radiologist may analyze images on the scanner workstation 12, but more often uses one of the remote monitors or viewing stations 22 which frees the CT scanner to image the next patient. Each viewing station 22 includes a series control algorithm or means or processor 48 which controls interface screens 46 and the retrieval and display of images from the archive 16. Rather than a central archive, the archive 16 can be disposed locally at the workstation 12, remotely at one of the devices connected to the hospital network 14, on compact discs and the like. An archive management and access system 50 organizes images from the archive in the hierarchical structure with a patient study 60 as a top level under each patient. From a listing of patients, the radiologist selects the patient to be diagnosed which brings up a listing of the patient's studies available from the archive 16. Each patient study includes one or more series 62. Each series 62 includes a plurality of images 64. Of course, a patient typically has more than one study which may have been generated on other imaging modalities or the same modality at an earlier time. The operator uses an operator input device, such as a keyboard or mouse 52 to interact with the records in the archive 16 by navigating the application interface screens 46.

With continuing reference to FIG. 1 and further reference to FIG. 2, the interface screen 46 includes a workflow bar 100 across the top of the screen 46 which guides the user activity sessions. The workflow bar 100 includes buttons 102, 104, 106, 108 that become highlighted to guide the user through each session. The interface screen 46 further includes a control panel 120 located to the left of the interface screen 46. A viewer or viewer screen 122 allows a user to view patient studies in various modes. By default, the viewer 122 is set to a CT viewer or button 124 but can be changed to various viewer environments by clicking on a viewer pull down arrow 126. An application screen 128 allows the user to load an application and begin image processing and analysis function. When the user clicks on an application down arrow 130 of an application button 132, a pull-down screen of application icons (not shown) is displayed. The user can select various applications such as exemplary combine images icon. Other examples of icons are lung, cardiac and the like. A remote reconstruction panel or screen 140 allows the user to perform remote reconstruction. The remote reconstruction panel 140 includes, for example, view reconstruction and background reconstruction buttons 142, 144. An archive manager toolbox or screen 150 provides access to various power management functions. A snagit browser button or icon 152 launches the browser of the database which includes the files that had been previously saved. Such files, for example, can include studies, movie files, text files, and graphic files. A quick film button or icon 154 allows the user to send images to filming directly from the archive manager screen 150. A “Copy To” button or icon 156 allows the user to copy the currently selected items to another device. A quick split button or icon 158 allows the user to split one long series into several series, such as a run off series can be split into a head, chest, abdomen and the like virtual series. A status panel or screen 160 provides information about status of the system. For example, a local label 162 shows the relative free space on the local disk. An EOD label 164 shows the relative free space on the erasable optical drive. A QM label 166 (queue manager) shows how many items are in the queue for transfer and how many have failed to transfer. A preferences button 170 allows the user to change various configurations of the system. A log out button 172 allows the user to exit the session.

A selected device screen 174 on the top of the screen 46 allows the user to select a device. To prevent patient list confusion, only one device may be selected at a time. When the user clicks on a down arrow 176 of a selected device button 178, the device list is displayed (not shown). The list offers local and remote applications. The user clicks on the device, such as local, remote, etc., the user wants to access. A stop connection button 180 is active when the user is connected to a remote device. To end the network connection to a remote device, the user clicks on the stop connection button 180. A patient list 182 displays the studies that are available in the archive 16. A filter algorithm or means 184 sorts or limits the patient list 182 by a data field and/or by the elapsed time since the study. By clicking on a down arrow 186 in a first field 188, the user can select to filter by various study parameters. For example, in FIG. 2, only cardiac studies are displayed. By clicking in a second field 190, the user can enter text that is used to filter, for example, the user can select patient ID and enter 12345. Only the patients whose patient ID numbers begin with 12345 are displayed. By clicking on a down arrow 192 in a third field 194, the user can select to filter by date. Similar filtering by number of series and number of images per series are also available. After the user selects the filtering parameters, the user clicks on a find button 196, and the patient list is updated with the filtered studies displayed. A remove filter button or icon 198 resets the filtering function, restoring the full list. An update screen content button or icon 200 refreshes the list with newly arrived studies. After the user selects a study, by, for example, highlighting the study in the patient list 182, a thumbnail display of an exemplary image of each series of the selected study is displayed in the lower portion of the screen 46. For example, the study can include one, two, three, four, five, six or more series which are be displayed on the bottom portion of the screen 46 and are accessible by scrolling from left to right. The user can select several studies and generate the thumbnail display for each series of each study. The user selects one or more series the user wants to access and analyze by using shift and control keys, the mouse to highlight the group of series and the like. The selected series are highlighted, for example, in a blue color. A view port for every series opens automatically. To unselect the series or a group of series, the user can do select, highlight, etc., of the previously selected items as known in the Windows environment. If more series are displayed than fit on the screen a scroll bar enables the viewer to move among them. The series are preferably sorted to move the selected series together for easier navigation.

With continuing reference to FIG. 2 and further reference to FIG. 3, each series control screen 202 includes an active image display or screen 204 which displays a selected image 206 of the series. Initially, by default, the active image display 204 displays a middle image in the image list, although other defaults can be selected. The active image display 204 includes windows, icons, buttons, sliders, pull down menus, and the like to control image selection and display. A minimum image number window or field 208 and a minimum image number slider 210 allows the user to select a minimum image number from the image list, i.e. a first side of the displayable volume. Initially, by default, the minimum image number in the minimum image window 208 and by a position of the minimum image number slider 210 on a numeric scale 212 is set to the initial image in the image list, such as image 0. A maximum image number window or field 214 and a maximum image number slider 216 allows the user to select a maximum image number from the image list, i.e. the opposite side of Initially, by default, the maximum image number in the maximum image number window 214 and by a position of the maximum image number slider 216 on the numeric scale 212 is set to the maximum image in the image list. A properties selection window or menu 220 allows the user to specify how to display the selected images. Initially, by default, the properties selection window 220 is set to “Every Image” which prompts the system to display every image.

As discussed in detail below, the active image display 204 displays the image of the last image adjusted by means of one of the minimum image number window 208, minimum image number slider 210, maximum image number window 214, and maximum image number slider 216. The image is preferably bigger the standard DICOM thumbnail (64×64); the size should be big enough to obtain a good idea of the location within the anatomy. In one embodiment, the active image display 204 includes manipulation tools associated with the displayed image to allow for adjustments in window/level control setting, and the like. For example, double clicking on the displayed image may act as an event to begin an operation.

With continuing reference to FIG. 3 and further reference to FIG. 4, a minimum image number algorithm or means 230 allows selecting the minimum image number corresponding to a minimum image or an initial image which is used when the sub-selection is performed. For example, as the user types in an image number in the minimum image number window 208, the active image display 204 displays the corresponding selected image 206. If the typed image number is lower than the initial image, such as image 0, the value of the minimum image number in the minimum image number window 208 is set to the initial image in the image list, e.g. image 0. If the minimum image number which is typed in the minimum image number window 208 is greater than the maximum image number in the image list, the value of the minimum image number is automatically set to the maximum image number in the image list. If the minimum image number which is typed in the minimum image number window 208 is greater than the maximum image number which is displayed in the maximum image number window 214, the image number in the maximum image number window 214 is adjusted to correspondingly match the image number of the minimum image number window 208. Adjusting an image number in the minimum image number window 208 causes the adjustment of the minimum image number slider 210 a new position on the numeric scale 212 which reflects the newly adjusted minimum image number in the minimum image number window 208.

The minimum image number slider 210 shows in a slider format the minimum image number which is used when the sub-selection is performed. Adjusting the minimum image slider 210 on the numeric scale 212 causes the minimum image number window 208 to update to the newly adjusted image number indicated by the position of the minimum image slider 210. The active image display 204 is updated to display the selected image 206 which corresponds to the adjusted slider minimum image number. If the minimum image slider 210 is moved to exceed the image number as indicated by the position of the maximum image number slider 216, the maximum image slider is adjusted to match the newly adjusted image number indicated by the position of the minimum image number slider 210. The maximum image number is updated in the maximum image number window 214 to the correct corresponding image number likewise. The minimum image number slider 210 is given a priority over the maximum image slider 216 in the case when the sliders 210, 216 are at the same position. When the user clicks at that position and begins to adjust, the minimum image slider 210 is adjusted. If the user clicks on the minimum image number slider 210, the active image display 204 is updated to the image number indicated by the position of the minimum image number slider 210.

A maximum image number algorithm or means 232 allows selecting the maximum image number corresponding to a maximum image or a last image which is used when the sub-selection is performed. Adjusting the maximum image number slider 216 on the numeric scale 212 causes the maximum image number window 214 to update to the newly adjusted image number as indicated by the position of the maximum image number slider 216. The active image display 204 is updated to display the selected image 206 which corresponds to the new position of the maximum image number slider 216.

If the maximum image number slider 216 is moved to precede the image number as indicated by the position of the minimum image number slider 210 on the numeric scale 212, the minimum image slider 210 is adjusted to match the newly adjusted image number indicated by the position of the maximum image number slider 216. The image number is updated in the minimum image number window 208 to the correct corresponding image number likewise. If the user clicks on the maximum image number slider 216, the active image display 204 is updated to the image number indicated by the current position of the maximum image number slider 216 on the numeric scale 212.

The maximum image number window 214 allows the user to select the maximum image number by typing in the number in the maximum image window 214. The active image display 204 displays a corresponding selected image 206. If the typed maximum image number is lower than the initial image number in the image list, such as image 0, the value of the maximum image number in the maximum image window 214 is set to the initial image number of the image list, e.g. image 0. If the maximum image number, which is typed in the maximum image window 214, is greater than the maximum image number of the image list, the value of the maximum image number in the maximum image window 214 is set to the maximum image number of the image list. If the maximum image number, which is typed in the maximum image window 214, is lower than the minimum image number displayed in the minimum image number window 208, the minimum image number in the minimum image number window 208 is set to the number newly adjusted and displayed in the maximum image window 214, e.g. the minimum image number is set to be equal to the maximum image number. The position of the maximum image number slider 216 is adjusted to match the image number of the maximum image number window 214.

In this manner, only the currently selected image is loaded for the display on the active image display 204. Because the system does not load all of the images associated with a selected patient, the image recalls, displays, and changes are substantially instantaneous.

A properties selection algorithm or means 234 specifies what to do with the images selected by the minimum and maximum image numbers. For example, the properties selection menu 220 includes a drop down menu which includes fields which allow the user to specify a display of every image, every other image, every n image, step in R millimeter steps, and the like. The properties selection means 234 allows the user to combine every other image, every n image, etc. into slabs so that fewer slabs need to be examined.

A series control window or means 236 includes a pull down contextual menu or control menu 238 which includes fields which allow the user to optimize the control procedure. For example, the control menu 238 includes a “Select All” field 240. When the “Select All” field 240 is selected by the user, all or some of the series control screen 202 control windows, fields, sliders, etc. are reset to the initial default values. For example, the minimum image number window 208 and the minimum image number slider 210 are reset to the initial image in the image list, such as image 0. The maximum image number window 214 and the maximum image number slider 216 are reset to the maximum image number of the image list. The active image display 204 is reset to display the middle image. The properties selection window 220 is reset to select a display of “Every Image”.

When a “Link/Apply to All” field 242 is selected by the user, the sub-selection settings of the current series control screen 202 is applied to all selected series. Such locking of images in the selected series can be used, for example, to make simultaneous adjustments on all of the selected series, or to bring different series into registration and select from all the series concurrently. This enables the user to set the minimum image in all linked series to a common anatomical location and to set the maximum image in all linked series to a common anatomical location. Then, as the user steps through the image volume between the common minimum and maximum anatomical locations, all linked series step together such that the same slice is displayed from every linked series. This linking technique can be used, for example, to link series from studies of a common organ taken periodically to show the progression of a disease or tumor. This linking technique can also be used to link contemporaneous studies of a common organ with different imaging modalities.

When a “Select Single Series” field 244 is selected by the user, the maximum image number slider 216 is removed. The maximum image number window 214 assumes the functionality of the minimum image number window 208 and is controlled by the minimum image number window 208 and minimum image number slider 210. The “Select Single Series” option is a quick way to select a single image and primarily used on scanner consoles. When a “Display DICOM information” field 246 is selected by the user, the information about the selected series and selected active image is displayed.

Optionally, the control menu 238 includes a “Open Image List” field. When the “Open Image List” field is selected by the user, a dialog box opens. The dialog box displays in a table format a list of the images in the series. The user can select a specific range of images from the list that upon closure of the dialog box is reflected on the series control screen 202. As another example, the control menu 238 includes a “Show Image List” field. When the “Show Image List” field is selected by the user, an image list is displayed in place of the DICOM image.

In the manner described above, the user can load a sub-selected series, along with the whole series, to an application/viewer, have the selection filmed, copy the selection to another device, or perform any other standard operation requiring a selection of images.

The invention has been described with reference to the preferred embodiments. Modifications and alterations may occur to others upon a reading and understanding of the preceding detailed description. It is intended that the invention be constructed as including all such modifications and alterations insofar as they come within the scope of the appended claims or the equivalents thereof.

1. A diagnostic imaging system comprising:
a display; and
a series control algorithm for generating an interactive user interface screen on the display, which series control algorithm enables a user to simultaneously control series and image levels operations associated with a selected study by interactively selecting and viewing medical images retrieved from an archive, which includes a plurality of the medical images hierarchically organized at study, series and image levels, at the series level.

2. The system as set forth in claim 1, wherein the series control algorithm generates a plurality of interactive series control user interface screens on the display, which each series control interface screen displays a series of the selected study, from which series control interface screens the user interactively designates images from the displayed series.

3. The system as set forth in claim 2, wherein each series control interface screen includes:
an active image display window on which a currently selected one of the images of the corresponding series is displayed.

4. The system as set forth in claim 3, wherein the series control algorithm includes:
a minimum image number selector or algorithm for designating via the series control screen a minimum image number corresponding to a minimum desired image corresponding to one end of an anatomical study region.

5. The system as set forth in claim 4, wherein the minimum image number selector designates the minimum image number in response to receiving a minimum image number entered by the user into a minimum image number data field displayed on the series control interface screen or sliding a minimum image number slider to a desired minimum image number position on a numeric scale displayed on the series control interface screen.

6. The system as set forth in claim 3, wherein the series control algorithm includes:
a maximum image selector or algorithm for designating via the series control screen a maximum image corresponding to a maximum desired image corresponding to another end of an anatomical study region.

7. The system as set forth in claim 6, wherein the maximum image number selector designates the maximum image number in response to receiving a maximum image number entered by the user into a maximum image number data field displayed on the series control interface screen or sliding a maximum image number slider to a desired maximum image number position on a numeric scale displayed on the series control interface screen.

8. The system as set forth in claim 3, wherein the series control algorithm includes:
a properties selecting algorithm for selecting images of a selected series for display on its corresponding interface screen active display window.

9. The system as set forth in claim 8, wherein the visualization includes one of:
selecting every image for display;
selecting every n^{th} image for display; and
merging individual images into slabs and selecting slabs for display.

10. The system as set forth in claim 8, further including:
a user selectable link field which in response to a user selection controls the property selection algorithm to select anatomically corresponding images for display in the active display window of each selected series.

11. A method for displaying medical images, the method comprising:
storing a plurality of medical images which are hierarchically organized by patient at study, series, and image levels;
displaying an interactive user interface screen on the display; and
with the displayed interface screen, interactively selecting and viewing the medical images concurrently from a plurality of series.

12. The method as set forth in claim 11, further including:
designating a study; and
displaying each series of the designated study on an associated interactive series control user interface screen on the display.

13. The method as set forth in claim 12, wherein displaying each series includes:
displaying a currently selected image from an associated series on an active image display window; and,
displaying control icons for controlling which image of the series is displayed.

14. The method as set forth in claim 13, further including:
selecting a minimum image number corresponding to a desired minimum image of the series control screen with one of the control icons.

15. The method as set forth in claim 14, further including:
displaying an associated minimum image based on the minimum image number selection.

16. The method as set forth in claim 13, further including:
selecting a maximum image number corresponding to a desired maximum image on the series control screen.

17. The method as set forth in claim 16, further including:
displaying an associated maximum image based on the maximum image number selection.

18. The method as set forth in claim 13, further including:
selecting a visualization pattern for viewing individual images of the selected series.

19. The method as set forth in claim 18, further including:
displaying every image;
display of every n^{th} image; and
merging individual images into slabs.

20. The method as set forth in claim 18, further including:
in response to selecting the visualization pattern, selecting anatomically corresponding images for display in the active display window of each selected series.

21. A processor programmed to perform the method of claim 11.

22. An apparatus comprising:
a display;
a series control means for generating an interactive user interface screen on the display, each interactive user interface screen including series control screens which enable a user to simultaneously control series and image levels operations associated with a selected study by interactively selecting and viewing at a series level medical images retrieved from an archives which includes a plurality of medical images hierarchically organized at study, series and image levels;
a minimum image selecting means for designating a first image corresponding to a starting border of a region of interest on each series control screen;
a maximum image selecting means for designating a second image corresponding to an ending border of the region of interest on each series control screen; and
a linking means for locking the displayed images in each selected series to correspond anatomically with each other.
